(19) United States
(12) Patent Application Publication
(10) Pub. No.: US 2014/0201000 A1
(43) Pub. Date: Jul. 17, 2014

(54) REAL TIME MECHANISM FOR LOCATION BASED MESSAGING USING WIRELESS NETWORKS

(71) Applicant: CISCO TECHNOLOGY, INC., San Jose, CA (US)

(72) Inventors: Ravi AKIREDDY, Santa Clara, CA (US); Esteban Raul TORRES, San Francisco, CA (US); Robert J. FRIDAY, Los Gatos, CA (US); Sujai HAJELA, Saratoga, CA (US); Uday Kumar PYDA, Sunnyvale, CA (US)

(73) Assignee: Cisco Technology, Inc., San Jose, CA (US)

(21) Appl. No.: 13/741,117

(22) Filed: Jan. 14, 2013

(51) Int. Cl. G06Q 30/02

(52) U.S. Cl. CPC G06Q 30/0261
USPC 705/14.58

(57) ABSTRACT

In an example embodiment disclosed herein is an apparatus comprising an interface and mobile billboard logic that is coupled with the interface and operable to communicate with an associated device via the interface. The mobile billboard logic obtains location data for the associated device. The mobile billboard logic determines whether a predetermined trigger condition has been met. The mobile billboard logic selectively sends data representative of an advertisement to the associated device to be displayed on a web page being requested by the associated device based on the location of the associated device and whether the predetermined condition has been met.

### TECHNICAL FIELD

The present disclosure relates generally to providing advertisements on a wireless network.

### BACKGROUND

Enterprises spend substantial amounts of money to develop Customer Relationship Management (CRM) systems. The CRM systems are designed to collect customer data and analyze customer data in an effort to more effectively market goods and services to the customer.

### BRIEF DESCRIPTION OF THE DRAWINGS

The accompanying drawings incorporated herein and forming a part of the specification illustrate the example embodiments.

FIG. 1 is a functional block diagram illustrating an example of a network architecture upon which an example embodiment can be implemented.

FIG. 2 is a block diagram illustrating an example of a mobile billboard device.

FIG. 3 is a block diagram that illustrates a computer system 300 upon which an example embodiment may be implemented.

FIG. 4 illustrates an example of a display on a user device in accordance with an example embodiment.

FIG. 5 illustrates an second example of a display on a user device in accordance with an example embodiment.

FIG. 6 illustrates an example of a methodology for providing a real-time mechanism for location based messaging on a wireless network.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, logic encoded in a tangible, non-transitory computer readable medium for execution by a processor. The logic when executed operable to obtain location data for an associated device and determine whether a predetermined trigger condition has been met. The logic is further operable to selectively send data representative of an advertisement to the associated device to be displayed on a web page being requested by the associated device based on the location of the associated device and whether the predetermined condition has been met.

In accordance with an example embodiment, there is disclosed herein, an apparatus comprising an interface and mobile billboard logic that is coupled with the interface and operable to communicate with an associated device via the interface. The mobile billboard logic obtains location data for the associated device. The mobile billboard logic determines whether a predetermined trigger condition has been met. The mobile billboard logic selectively sends data representative of an advertisement to the associated device to be displayed on a web page being requested by the associated device based on the location of the associated device and whether the predetermined condition has been met.

In accordance with an example embodiment, there is disclosed herein a method that comprises obtaining location data for an associated device and determining whether a predetermined trigger condition has been met. Data representative of a first advertisement is provided to the associated device based on the location of the associated device and determining that the predetermined trigger condition has not been met. Data representative of a second advertisement is provided to the associated device based on the location of the associated device and determining that the predetermined trigger condition has been met.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Disclosed in an example embodiment herein is a mobile billboard, which may also be referred to herein as a billboard exchange (“BBX”) for selectively providing advertisements to devices associated with a network. The mobile billboard may suitably comprise a hypertext transfer protocol (HTTP) proxy, a runtime module, a data repository, and an analytics module.

The HTTP proxy enables an enterprise to insert information on top of a web page that is being provided to a device associated with the network. In particular embodiments, the HTTP proxy does not modify or alter the web page that is being provided to the device, but presents new information on top of the web page. The context of the web page remains the same.

The runtime module (or engine) provides a web-based graphical user interface (GUI) for configuring the mobile billboard. For example, the runtime module can allow an administrator to input data such as services available, special offers, advertisements, etc. to display on top of the web page being viewed by the associated device. The runtime module can also receive location based rules to trigger the display of predefined messages. The runtime, module stores the input data and rules. The runtime module comprises an application programing interface (“API”) to interface with ad servers of advertisers that are providing location based advertisements.

The data repository may suitably comprise a database for storing historical data. For example, the data repository may store historical data for the associated mobile device, such as locations visited and amount of time spent at the locations. The data repository may obtain location data for the associated device from a server providing location based data, such as a mobility services engine. (“MSE”) available from Cisco Systems, Inc., 170 West Tasman Dr., San Jose, Calif. 95134.

The analytics module obtains location data for an associated device, and provides triggers to the runtime module for sending location based messages. As will be disclosed in more detail herein, the triggers may be any predefined condition.

For example, using the GUI, an administrator for a network can upload their billboard icon and configure the available services, such as, for example, uploading a map icon for maps and linking the map data to a MSE API to retrieve the relevant map and location of an associated device to enable the device to display the map. The administrator may also upload a “deals” icon associated with currently available deals available from a venue associated with the network. The deals may be based on any predefined criteria, such as a predefined time period and/or a predefined location. Network specific services may also be specified.

Once the mobile billboard is activated, when guests with mobile devices enter an areas serviced by the network, the mobile devices associate with the network. When a guest opens a web browser on a mobile device, the mobile billboard (or BBX server) sends an icon that appears in the browser's viewing area (for example at the bottom of the browser) that indicates mobile billboard services are available. The icon is displayed on every web page viewed by the browser while associated with the network. In an example embodiment, when the guest selects the mobile billboard icon, a web banner is opened up (for example, at the bottom or top of the web page) that indicates the mobile billboard services that are available from the network. The web banner may suitably comprise icons to represent the services available from the network.

In an example embodiment, the mobile billboard provides real-time location-based messaging to devices associated with the network. For example, using the GUI, an administrator can define points of interests (POIs) within the network using map data for the network. The administrator can assign messages display rules (or triggers or thresholds) to the POIs. For example, a pool bar can be a POI, and a message display rule can be based on the number of people, dwell time, day of the week, time of day, season, etc. The runtime module would send the message display rules and POIs to the analytics module. The analytics module can execute an algorithm in the background in real-time to determine if the conditions of a message display trigger (or threshold) have been met. If a condition has been met, the appropriate message is provided to devices associated with the network. The devices receiving the message may be located in a POI, or may be located anywhere in the network depending on the rules established by the administrator.

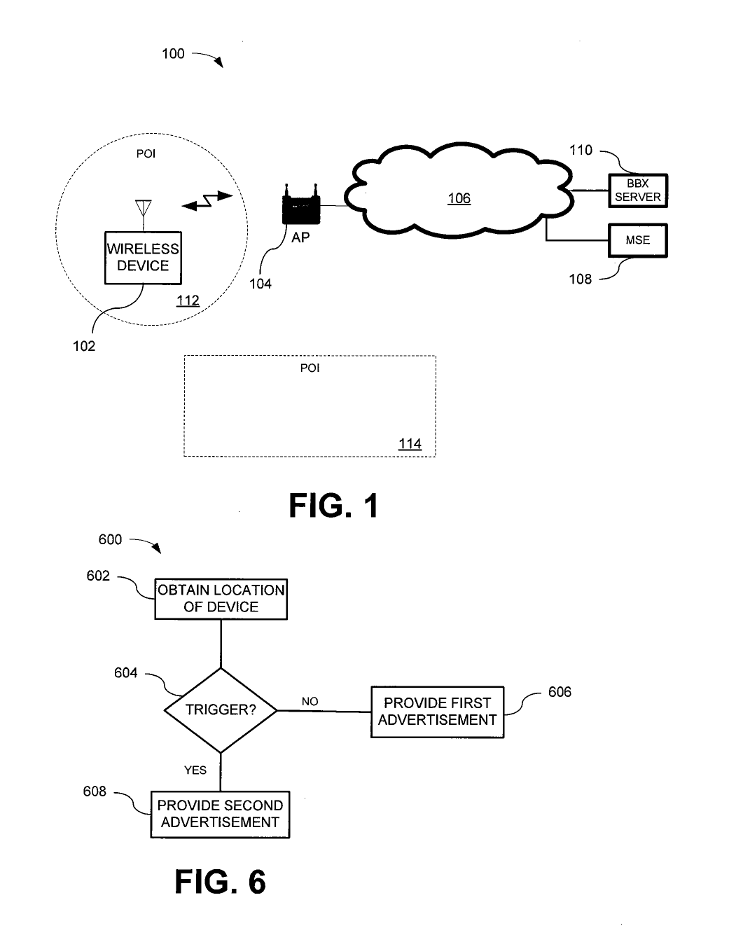

FIG. 1 is a simplified functional block diagram illustrating an example of a network architecture 100 upon which an example embodiment can be implemented. In the illustrated example, a wireless device 102 is in wireless communication with an access point (AP) 104. The AP 104 is coupled with network 106. Those skilled in the art should readily appreciate that other devices such as controllers, switches, and gateways may be disposed between AP 104 and network 106. A location server (MSE) 108 and a mobile billboard (BBX) server 110 are coupled with network 106. Thus, in accordance with an example embodiment, advertisements may be sent from BBX server 110 to wireless device 102 via network 106 and AP 104. The BBX server 110 may obtain location data for wireless device 102 from MSE 108, and accordingly may send advertisements based on the location of the wireless device 102. For ease of illustrating the examples that will be described herein, two points of interests (POIs) 112, 114 are illustrated. In the illustrated example, the wireless device 102 is located within the first POI 112, and outside the second POI 114. Those skilled in the art should readily appreciate that the principles described in the example embodiments herein can be applied to networks having any physically realizable number of wireless devices, POIs, and/or APs, therefore, the principles of the example embodiments described herein should not be construed as limited to any particular number of devices, layouts and/or POIs. Moreover, although the BBX server 110 and MSE 108 are illustrated as separate functional blocks, those skilled in the art should readily appreciate that the functionality provided by these devices may be provided by a single device, or by multiple devices.

In an example embodiment, BBX server 110 obtains location data for wireless device 102 that is associated with AP 104. For example, the BBX server 110 may obtain location data from MSE 108. The BBX server 110 determines whether a predetermined trigger condition has been met. The BBX server 110 selectively sends an advertisement to the wireless device 102 to be displayed on a web page being requested by the wireless device 102 based on the location of the wireless device 102 and whether the predetermined trigger condition has been met.

The predetermined trigger condition may be any predefined criteria. For example, the predetermined trigger condition is based on a number of associated devices at a point of interest, such as the first POI 112 and/or the second POI 114.

In an example embodiment, the predetermined trigger condition is the number of associated devices at the point of interest exceeding a threshold. For example, if the number of wireless devices at the first POI 112 exceeds a predetermined threshold, BBX server 110 may send an advertisement to the wireless device 102 to entice a user associated with wireless device 102 to go to the second POI 114.

In an example embodiment, the predetermined trigger condition is the number of associated devices at the point of interest being less than a threshold. For example, if the number of associated devices at the second POI 114 is below a predetermined threshold, BBX server 110 may send an advertisement to the wireless device 102 to entice a user associated with wireless device 102 to go to the second POI 114.

In an example embodiment, the predetermined condition is based on the number of associated devices at a first point of interest exceeding a first threshold and the number of associated devices at a second point of interest is below a second threshold. For example, if the number of wireless devices located at the first POI 112 is greater than a first threshold, and the number of wireless devices located at the second POI 114 is below a second threshold, BBX server 110 can send an advertisement to devices located within the first POI 112, such as wireless device 102, to entice a user associated with wireless device 102 to go to the second POI 114. The first threshold can be different than the second threshold or equal to the second threshold.

In an example embodiment, the predetermined trigger condition is based on an amount of time the associated device dwells within a predefined area. For example, if based on historical data, a determination is made that wireless device 102 has been within the first POI 112 for longer than a predetermined amount of time, BBX server 110 can send an advertisement to the wireless device 102 to entice a user associated with wireless device 102 to go to the second POI 114 and/or encourage the user to spend more time by sending an offer or deal that is valid at that POI.

In an example embodiment, the predetermined trigger condition can be based on a time period. For example, the predetermined trigger condition can be based on a day of week, time of day, and/or season. Moreover, as those skilled in the art can readily appreciate, a plurality of predetermined trigger conditions may be defined and associated with a corresponding plurality of advertisements.

The following examples illustrate potential uses for the example embodiments described herein. For example, if a venue has a pool bar (e.g., a first POI) that is overcrowded, however, other bars/lounges (e.g., second POI) at the venue are not filled, an advertisement, e.g., incentive, can be sent (such as by BBX server 110) to wireless devices at the pool bar to entice people at the pool bar to move to one of the lesser filled venues. As another example, as people are leaving a theater show at a resort, an advertisement can be sent to entice the patrons to visit other facilities within the venue (e.g., drink specials for a lounge or restaurant, free tokens for slot machines, etc.). As another example, a hotel night club that is not very busy can send out advertisements to patrons within the hotel to entice people in the hotel to visit the night club (e.g., advertise happy hour drink specials, other specials such as ladies nights, etc.). As yet another example, if someone is detected waiting in the lobby of a venue for a predetermined amount of time (for example more than 20 minutes), an advertisement can be sent to that person to entice them to have a drink at the bar, or visit a gift shop, etc.

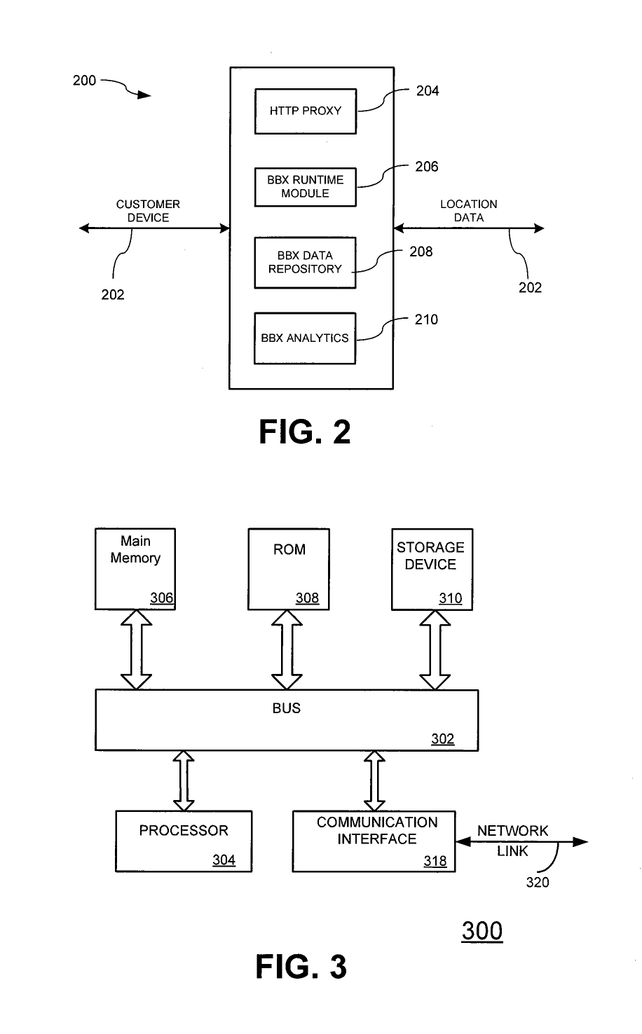

FIG. 2 is a block diagram illustrating an example of a mobile billboard device 200. For example, the mobile billboard device 200 can be employed to implement the functionality of the BBX server 110 described in FIG. 1.

The mobile billboard device 200 comprises one or more interfaces 202 for communicating with external devices. For example a first interface may be employed to communicate with associated wireless devices and a second interface may be employed for communicating with a location (or mobility) server to obtain the location of the associated wireless devices, or a single interface may be employed to communicate with associated wireless devices and the location server.

The mobile billboard device 200 further comprises logic (or mobile billboard logic) for implementing the functionality described herein. The logic is operable to send and receive data via the one or more interfaces 202. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In the illustrated example, the logic comprises a HTTP proxy module 204, a BBX runtime module 206, a BBX data repository (or memory) 208, and a BBX analytics module 210.

The HTTP proxy module 204 enables an enterprise to insert information on top of a web page that is being provided to a device associated with the network. In particular embodiments, the HTTP proxy does not modify or alter the web page that is being provided to the device, but presents new information on top of the web page. The context of the web page remains the same. The information inserted on top of the web page may be a banner and/or at least one icon.

The runtime module (or engine) 206 provides a web-based graphical user interface (GUI) for configuring the mobile billboard. For example, the runtime module 206 can allow an administrator to input data such as services available, special offers, advertisements, etc. to display on top of the web page being viewed by the associated device. The runtime module 206 can also receive location based rules to trigger the display of predefined messages. The runtime module 206 stores the input data and rules. In particular embodiments, the runtime module 206 comprises an application programing interface (“API”) to interface with ad servers of advertisers that are providing location based advertisements.

In an example embodiment, the runtime module 206 may also display data representative of the location of wireless devices in the network. For example, the runtime module may provide data indicating a number of mobile devices that are within, or outside of, a point of interest. This can allow an administrator to monitor current activity, and in particular embodiments, enable the administrator to send directed advertisements to a set of mobile devices in the network. For example, if a particular point of interest is not very busy, the administrator can send advertisements to selected mobile devices to entice the users of those devices to migrate to the point of interest. As another example, if another point of interest is at or exceeding its capacity, the administrator can send a selected advertisement to mobile devices at the point of interest to entice the user associated with the mobile devices to migrate to another point of interest.

The data repository 208 may suitably comprise a database for storing historical data. For example, the data repository may store historical data for the associated mobile device, such as websites visited, locations visited and amount of time spent at the locations.

The analytics module 210 obtains location data for an associated device, and provides triggers to the runtime module for sending location based messages. As disclosed in more detail herein, the triggers may be any predefined condition. The analytics module 210 may employ data stored in the data repository 208 to determine patterns and/or user behavior and trends with respect to dimensions like time (e.g., time of the day, day of the week/month etc.), user demographics, etc. to influence policy based trigger(s).

FIG. 3 is a block diagram that illustrates a computer system 300 upon which an example embodiment may be implemented. Computer system 300 may be employed to implement the functionality of BBX server 110 described in FIG. 1 and/or the logic of the mobile billboard 200 described in FIG. 2.

Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, optical disk, and/or flash storage, is provided and coupled to bus 302 for storing information and instructions.

An aspect of the example embodiment is related to the use of computer system 300 for providing a real-time mechanism for location based messaging on a network. According to an example embodiment, a real-time mechanism for location based messaging on a network is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media, and volatile media. Non-volatile media include, for example, optical or magnetic disks, such as storage device 310. Volatile media include dynamic memory such as main memory 306. As used herein, tangible media may include any non-transitory media such as a volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 300 also includes a communication interface 318 coupled to bus 302. Communication interface 318 provides a two-way data communication coupling computer system 300 to a network link 320 that is connected to a network (not shown). For example, communication interface 318 may allow computer system 300 to obtain the location of a wireless device associated with a wireless network. In an example embodiment, communication interface 318 is employed to send messages, such as selective advertisements, to a wireless device.

Communication interface 318 may be any suitable type of interface for providing data communication. For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information.

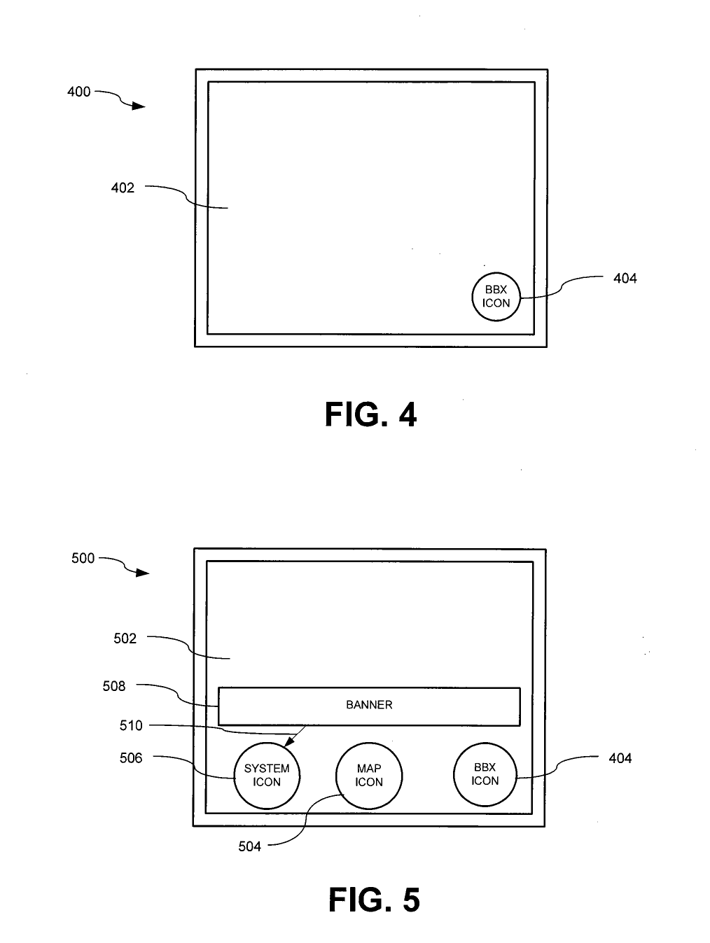

FIG. 4 illustrates an example of a display 402 on a user device 400 in accordance with an example embodiment. In an example embodiment, the user device 400 selectively receives advertisements from a mobile billboard, such as BBX server 110 described in FIG. 1 and/or the mobile billboard 200 described in FIG. 2. A BBX icon 404 is disposed on display 402. The BBX icon 404 may suitably comprise graphical and/or textual data to indicate to a user associated with the device 400 that additional services are available. In an example embodiment, a HTTP proxy module in the mobile billboard inserts the icon on top of a web page that is being provided to the device 400. In particular embodiments, the HTTP proxy does not modify or alter the web page that is being provided to the device 400, but presents the icon 404 on top of the web page. The context of the web page remains the same. In particular embodiments, the information inserted on top of the web page may be a banner (not shown, see for example FIG. 5 described herein infra) and/or at least one icon.

FIG. 5 illustrates an second example of a display 502 on a user device 500 in accordance with an example embodiment. This example includes additional icons 504, 506 and a banner 508.

In the illustrated example, icon 504 is a map icon. When a user selects the map icon, the mobile billboard will provide map data to the device 500 to be displayed on display 502. The map data may include the location of mobile device 500, location of points of interests or establishments associated with the network, friends to a user associated with the wireless device 500, etc.

System icon 506 can be employed to obtain system services. For example, the system icon 506 may be employed to find stores, find products, find current sales, find coupons, etc.

Banner 508 may be provided by the mobile billboard to display advertisements selected for mobile device 500. In the illustrated example, a visual cue 510 is provided to indicate to an end user that the system icon 506 may be employed to obtain additional data about the selected advertisement.

In view of the foregoing structural and functional features described above, a methodology 600 in accordance with an example embodiment will be better appreciated with reference to FIG. 6. While, for purposes of simplicity of explanation, the methodology 600 of FIG. 6 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement the methodology 600. The methodology 600 described herein is suitably adapted to be implemented in hardware, software when executed by a processor, or a combination thereof. For example, methodology 600 can be implemented by the BBX server 110 described in FIG. 1, the mobile billboard 200 described in FIG. 2, and/or the computer system 300 described in FIG. 3.

At 602, the location of a mobile device, or the location of a plurality of mobile devices associated with a network, such as a wireless network, is obtained. The location data may indicate whether the mobile device, or which of the plurality of mobile devices, are within, or outside of, a point of interest.

At 604, a determination is made on whether a predetermined trigger condition has been met. The predetermined trigger condition may be any predefined criteria. For example, the predetermined trigger condition is based on a number of associated devices at a point of interest. Other trigger conditions may include, but are not limited to whether the number of associated devices at the point of interest exceeds a threshold, whether the number of associated devices at the point of interest is less than a threshold, whether the number of associated devices at a first point of interest exceeds a first threshold and the number of associated devices at a second point of interest is below a second threshold, the amount of time the associated device has dwelled within a predefined area, and/or a time period. For example, the predetermined trigger condition can based on a day of week, time of day, and/or season. Moreover, as those skilled in the art can readily appreciate, a plurality of predetermined trigger conditions may be defined and associated with a corresponding plurality of advertisements.

If the predetermined trigger condition has not been met at 604 (NO), at 606, a first advertisement associated with the location of the device is provided. The first advertisement may be a default advertisement, or any other suitable advertisement.

If the predetermined trigger condition has been met at 604 (YES), at 608, a second advertisement associated with the location of the device is provided. For example, the second advertisement may include an incentive to motivate a user associated with a wireless device to migrate to, or exit from, a point of interest.

As one skilled in the art can readily appreciate, the location of the device and/or the variable for the trigger condition can change over time. Therefore, methodology 600 may be repeated so that the advertisement being provided to the device changes as conditions change. The time period may be any suitable time period, which may be dependent on factors such as the speed of the equipment implementing the mobile device and/or the number of mobile devices associated with a particular network.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. Logic encoded in a tangible, non-transitory computer readable medium for execution by a processor, and when executed operable to:
obtain location data for an associated device;
determine whether a predetermined trigger condition has been met; and
selectively send data representative of an advertisement to the associated device to be displayed on a web page being requested by the associated device based on the location of the associated device and whether the predetermined trigger condition has been met.

2. The logic set forth in claim 1, wherein the predetermined trigger condition is based on a number of associated devices at a point of interest.

3. The logic set forth in claim 2, wherein the predetermined trigger condition is the number of associated devices at the point of interest exceeding a threshold.

4. The logic set forth in claim 2, wherein the predetermined trigger condition is the number of associated devices at the point of interest being less than a threshold.

5. The logic set forth in claim 2, wherein the predetermined condition is based on the number of associated devices at a first point of interest exceeding a first threshold and the number of associated devices at a second point of interest is below a second threshold.

6. The logic set forth in claim 5, wherein the first threshold is equal to the second threshold.

7. The logic set forth in claim 1, wherein the predetermined trigger condition is based on an amount of time the associated device dwells within a predefined area.

8. The logic set forth in claim 1, wherein the predetermined trigger condition is based on a day of week.

9. The logic set forth in claim 1, wherein the predetermined trigger condition is based on a time of day.

10. The logic set forth in claim 1, wherein the predetermined trigger is based on a season.

11. The logic set forth in claim 1, wherein the predetermined trigger is based on user demographics.

12. The logic set forth in claim 1, wherein the predetermined trigger is based on user browsing behavior.

13. An apparatus, comprising:
an interface;
mobile billboard logic coupled with the interface and operable to communicate with an associated device via the interface;
the mobile billboard logic obtains location data for the associated device;
the mobile billboard logic determines whether a predetermined trigger condition has been met; and
the mobile billboard logic selectively sends data representative of an advertisement to the associated device to be displayed on a web page being requested by the associated device based on the location of the associated device and whether the predetermined condition has been met.

14. The apparatus set forth in claim 13, wherein the predetermined trigger condition is a number of associated devices at a point of interest exceeding a threshold.

15. The apparatus set forth in claim 13, wherein the predetermined trigger condition is a number of associated devices at a point of interest being less than a threshold.

16. The apparatus set forth in claim 13, wherein the predetermined condition is based on a number of associated devices at a first point of interest exceeding a first threshold and a number of associated devices at a second point of interest is below a second threshold.

17. The apparatus set forth in claim 13, wherein the data representative of an advertisement comprises a banner and an icon.

18. The apparatus set forth in claim 13, wherein the data representative of an advertisement is for a first advertisement when the predetermined condition is not met; and,
wherein the data representative of an advertisement is for a second advertisement when the predetermined condition is met.

19. The apparatus set forth in claim 13, wherein the data representative of an advertisement comprises a first advertisement that is sent to associated devices at a first point of interest; and.
wherein the data representative of an advertisement comprises a second advertisement that is sent to associated devices at a second point of interest.

20. A method, comprising:
obtaining, by a processor, location data for an associated device;
determining, by a processor, whether a predetermined trigger condition has been met; and
providing data representative of a first advertisement to the associated device based on the location of the associated device and determining that the predetermined trigger condition has not been met; and
providing data representative of a second advertisement to the associated device based on the location of the associated device and determining that the predetermined trigger condition has been met.

21. The method set forth in claim 20, wherein the predetermined trigger condition is based on a number of associated devices at a point of interest.

22. The method set forth in claim 20, wherein the point of interest is at a different location than the location of the associated device.
